(19) United States
(12) Patent Application Publication
(10) Pub. No.: US 2024/0336454 A1
(43) Pub. Date: Oct. 10, 2024

(54) THREAD TRAVERSING DEVICE, THREAD GUIDE HOUSING AND METHOD

(71) Applicant: Saurer Spinning Solutions GmbH & Co. KG, Übach-Palenberg (DE)

(72) Inventors: Jan Dahlmanns, Gangelt (DE); Elisabeth Klaczynski, Erkelenz (DE); Michael Mohr, Schwalmtal (DE); Heinz-Josef Peuker, Wegberg (DE); Ken Sauren, Geilenkirchen (DE); Michael Steiner, Wegberg (DE)

(73) Assignee: Saurer Spinning Solutions GmbH & Co. KG, Übach-Palenberg (DE)

(21) Appl. No.: 18/622,901

(22) Filed: Mar. 30, 2024

(30) Foreign Application Priority Data
Apr. 5, 2023 (LU) 503857

(51) Int. Cl. B65H 54/70; B08B 5/02; B65H 54/28; B65H 57/00

(52) U.S. Cl. CPC B65H 54/702; B08B 5/02; B65H 54/2821; B65H 57/006; B65H 2406/12; B65H 2701/31

(57) ABSTRACT

A thread traversing device for a winding device of a textile machine producing cross-wound bobbins comprising a thread guide housing having a thread guide, a traversing device arranged to reversibly traverse along a direction of the axis of the cross-wound bobbin, and at least one overpressure system having at least one fluid guide. The thread guide housing is designed, and the traversing device is associated with the thread guide housing, such that the thread guide reversibly traverses in a work station of the textile machine along a direction of the axis of rotation of the cross-wound bobbin. The thread guide housing can be brought into fluidic communication with the fluid guide in order to apply overpressure to the thread guide housing, and at least one defined exit point is designed and arranged in such a way that fluid can be diverted through the defined exit point.

The invention relates to a thread traversing device for a winding device of a textile machine producing cross-wound bobbins. The invention further relates to a thread guide housing, in particular for a thread traversing device. The invention further relates to a textile machine. The invention relates to a method for cleaning a thread guide and/or a thread guide housing.

Thread traversing devices are known and are used in the manufacture of cross-wound bobbins in that they reversibly change a thread guide between two states. It is known that, on the one hand, the relevant textile bobbin is set in rotation and, on the other hand, the thread running onto the bobbin changes relatively quickly along the bobbin axis during the winding process. As a result, the guided thread is wound onto the cross-wound bobbin or a provided tube, which results in cross-winding that is caused by the traversing. This provides densely packed bobbins which also have a stable winding. Furthermore, the resulting textile bobbins can unwind particularly well; the thread can accordingly be unwound particularly well by machine, but does not fall off the roll by itself. In the process, the traversing takes place in particular in a direction of movement parallel to an axis of rotation of the cross-wound bobbin. An angled movement is also conceivable. Textile machines that use this technique are for example spinning machines and/or twisting machines.

The piecing process, but also the abrasion of the thread and/or yarn, can lead to contaminants in the winding device, but which can also be introduced into the thread traversing device. This can result in impairments in the production of cross-wound bobbins, which increases the downtimes of the machines for maintenance and repair. Furthermore, the production of the final product, the cross-wound bobbins, can be impaired.

It is therefore an object of the invention to improve the quality of cross-wound bobbin production, to increase the reproducibility of their production and the reproducibility of the resulting cross-wound bobbins, and to minimize downtimes and thereby to preserve resources.

The object is achieved by a thread traversing device with the features of claim 1. The object is further achieved by a thread guide housing with the features of claim 10. The object is further achieved by a textile machine with the features of claim 11. The object is further achieved by a cleaning method with the features of claim 12.

Advantageous embodiments of the invention are the subject matter of the dependent claims.

According to one aspect, the object is achieved by a thread traversing device with the features of claim 1.

A thread traversing device can be provided for a winding device of a textile machine producing cross-wound bobbins. The thread traversing device can have a thread guide housing which can have a thread guide. A traversing device is in particular designed and arranged to reversibly traverse along a direction of the axis of the cross-wound bobbin to be produced. At least one overpressure system can be provided which has at least one fluid guide. In this case, the thread guide housing can be designed and the traversing device can be associated with the thread guide housing in such a way that the thread guide can reversibly traverse in a workplace of the textile machine along a direction of the axis of rotation of the cross-wound bobbin to be produced. In this case, the thread guide housing can be brought into fluidic communication with the fluid guide in order to apply overpressure to the thread guide housing. At least one defined exit point can thereby be designed and arranged in such a way that fluid can be diverted through the defined exit point.

It can thereby be made possible to discharge contaminants from the thread guide housing. Alternatively or additionally, the thread guide can be kept free of contaminants or cleaned. The contaminants can lead to an impairment of the production of the cross-wound bobbins, and the reproducibility of their production can be limited. Interruptions in production which have to be used for cleaning processes can thereby occur. It may therefore be necessary for the cleaning to be performed, which leads to standstills of the textile machine. This is associated, in particular, with costs for the stoppages, but also with resources which have to be used for cleaning. The proposed thread traversing device can reduce the demand for interruptions, which can lead to longer running times of the textile machines, and wherein the reproducibility of the produced cross-wound bobbins is also improved. The thread traversing device can in particular be designed to apply positive overpressure to the thread guide housing. In this way, cyclic cleaning can take place. The cyclic application of overpressure enables efficient and resource-saving cleaning. Particularly preferably, the thread traversing device comprises means, in particular a control device, in order to pre-define cleaning cycles.

A pulling device, in particular an endless pulling device, can be provided as a traversing device, as is described elsewhere. Alternatively, however, a traversing device can also have a pull rod and/or a pull plate as a pulling device, to which a thread guide is connected in such a way as to enable a stroke movement of the thread guide largely parallel to the axis of rotation of the cross-wound bobbin or its tube. In this context, largely parallel means that an angled geometry—angled relative to the axis of rotation of the cross-wound bobbin during operation, can also be provided.

Thread traversing devices are in particular delimited to the outside by a thread guide housing. The traversing device can thereby traverse in the thread traversing device in order thereby to impart a stroke movement on the thread guide. The thread guide can thereby be moved from one side of the thread traversing device to another side of the thread traversing device.

A system for applying an overpressure with a fluid can be provided as an overpressure system. Overpressure is in particular a pressure that exceeds the (normal) pressure of the atmosphere, or a pressure that exceeds the internal pressure of a textile machine and/or the internal pressure of a thread guide housing. In particular, any fluid which does not damage the threads and the machine can be used as the fluid. Furthermore, air or compressed air can in particular be provided as the fluid, and also the application of nitrogen, for example from an evaporator. In this case, artificial air, dry air and nitrogen are particularly easy to handle. Artificial air is particularly clean, which can further increase cleaning efficiency.

A fluid guide is designed in particular to be able to guide a fluid in order to be able to apply an overpressure. Fluidic communication represents a connection whereby an exchange of information can be mediated via a fluid column in a fluid guide.

In particular, an opening, for example a hole, can be provided as at least one defined exit point. Alternatively or additionally, a nozzle can be provided. The defined exit point can be designed in such a way that an equilibrium with the applied overpressure can form. As a result, a maximum pressure can be set, for example, which can prevent damage to components. Furthermore, the overpressure can be reduced by the at least one defined exit point without being dependent on leaks. As a result, vibrations and turbulences can be reduced which can be introduced into the system if regions which are not provided for pressure compensation are used for pressure compensation. The risk of pressure-induced damage is also reduced. Operation can be improved by the defined exit point, since the pressure can accordingly be released in a targeted manner by a fluid flow. A valve can also be provided that regulates the pressure release. A pressure equilibrium can thereby be determined by selecting the type of the defined exit point in combination with the choice of the overpressure and the type of supply of the overpressure.

According to a further aspect, the pressurized fluid of the thread guide housing is applied in particular via at least one pressurized fluid connection. In particular, a compressed air connection can be provided as a pressurized fluid connection. The pressurized fluid is applied in such a way that pressurized fluid is applied to the interior of the thread guide housing. The interior of the thread guide housing can thereby be flushed in order to discharge contaminants from the thread guide housing. In particular, abrasion of yarn and thread can thereby also be discharged, which is why these contaminants accumulate more slowly in the thread guide housing or do not accumulate at all. As a result, the operation of the textile machine can be maintained for a longer time without interrupting operation due to maintenance and/or repair. The advantages described above can thereby be realized.

The pressurized fluid connection can in particular be arranged on at least one of the end faces in order to blow in a pressurized fluid inflow in particular parallel to a traversing direction. Furthermore, a fluid flow can in particular be designed in such a way that the entry of the fluid flow first blows on the areas which are at most at risk of contaminants.

The defined exit point can be designed in such a way that the pressurized fluid introduced into the interior of the thread guide housing can escape in a defined manner. This takes place in particular in such a way as to form a defined pressurized fluid flow in the interior of the thread guide housing. In particular, the vibrations and turbulences within the thread guide housing can be reduced by the defined fluid flow and the defined exit. It is also possible that no other accumulations of contaminants, for example on parts of the mechanics of the traversing device, are deposited, since a discharge of the contaminants via the defined outlet point is preferred, as opposed to leakage points that may first occur or leak points that may be randomly distributed.

The exit point can in particular be arranged on a side facing away from a work station in order to prevent a return of the contaminants into the work station. A direction outside the thread guide housing can thereby also be formed. This allows a material transport system to be formed.

The exit point is in particular a suction point. The suction point can be designed to be connected to a suction system in order to extract the pressurized fluid from the interior of the thread guide housing in a defined manner via the suction point in order to form a defined fluid flow in the interior of the thread guide housing. As a result, an overpressure equilibrium can be set in a defined manner by controlling the suction system, for example depending on the overpressure system. In particular, a laminar fluid flow can thereby be introduced which can in particular also be discharged in a laminar manner. As a result, it is possible for contaminants to be discharged in a targeted manner and not be forced out through unsuitable openings by overpressure, especially not through points that could (potentially) only be created by the overpressure.

According to one embodiment, at least one outlet point can be arranged and designed in such a way as to form a defined pressurized fluid flow which blows on the thread guide, in particular during a traversing process. The thread guide can thereby be cleaned in a targeted manner. The advantages described above are thereby realized. This embodiment can be combined with the other described embodiments and aspects, but can also be implemented in isolation. The blowing of the thread guide can also be referred to as external pressure application, compared to the internal pressure application of the interior of the thread guide housing.

The thread guide can be mounted movably on guide rods via guides via a thread guide carriage. The thread guide rods can be pressed into a press seat, wherein a gap is formed between the press seat and the guides. In this case, a gap can be provided in particular in the region of the zeroing of the thread guide carriage in order to receive fiber contaminants. The thread guide carriage can thereby reversibly assume a zero position. A reversible winding of the cross-wound bobbin is thereby made possible since the zero position defines the starting position of the thread guide carriage and thus the zero position of the thread guide during a winding of the cross-wound bobbin. Expressed in other words, a meandering or migrating zero can thereby be avoided or the occurrence thereof can be delayed, which makes it necessary to switch off the textile machine at least partially. The migration can be triggered by thread or yarn remnants being deposited between a stop position of a thread guide carriage around the guide rods, in particular in a zero position, which prevent a return to the previous zero (or the original zero). The meandering can be triggered, for example, by a compression of the impurity residues, which can be followed by a breaking away of the contaminants. The breakaway in particular shifts the zero again in the direction of the original zero. This can be followed by further deposits, which is why the zero can then again be pushed into the “other direction.” This can lead to offsets on the cross-wound bobbins, which can impair the quality of the bobbins.

According to a further aspect, the guides of the thread guide carriage can be designed in such a way that, in a stop position of the thread guide carriage at the press seat, a distance to the press seat in the region of the pressing in of the guide rods must be maintained. The zero can thereby be stabilized, which can lead to the advantages described above. The guides are in particular designed such that they at least partially surround the guide rods to enable a sliding bearing to enable the mobility of the thread guide carriage. The guides are set back relative to the region in which the guide rods are pressed into the press seat. The thread guide carriage can in particular have a side which bridges two parallel guide rods. The guides are in particular arranged in such a way that they do not project beyond a side edge. Alternatively, the guides can also be set back over the side that bridges two parallel guide rods, in the direction of a center line of the thread guide carriage. A distance from the region into which the thread guide rods are pressed can thereby be formed.

The distance thereby defines in particular a contaminant receiving region between the guides and the press seat. The zero can thereby be defined and maintained. Here and elsewhere, the zero is in particular the stop position of the thread guide carriage at a press seat on one side of the traversing device.

Alternatively or additionally, the press seat in the region of the pressing of the guide rods can be offset relative to a stop region for the stopping of the thread guide carriage in order to maintain a gap from the guides in a stop position of the thread guide carriage. The zero can thereby be stabilized, which can lead to the advantages described above. This can cause contaminants between a gap between the guides and the region where the guide rods are pressed in. In this embodiment, in particular the press seat is adapted to form the distance to the guides.

Alternatively or additionally, the guide rods can be ⅞ free. Further alternatively or additionally, the guide rods can be completely free. The zero can thereby be stabilized, which can lead to the advantages described above. In this case, the exposure of the guide rods refers to their circumference in a region where, in other embodiments, pressing in occurs. In other words, ⅞ of the circumference of the guide rod can thus be free in a corresponding region. Exposure can result in contaminants being removed from the guide rods to the outside. A collection of the contaminants described above can thus be delayed, in particular completely avoided.

According to a further aspect, an at least partial housing of a winding roller can be arranged and designed in such a way as to brake or block a fluid flow between the winding roller and at least one element selected from the thread guide or the thread guide housing. As a result, it is more difficult, in particular for the contaminants, for them to be swirled up by the movement of the winding roller and then reintroduced into the thread guide housing in an air flow which is produced by the swirling of the air from the rotation of the winding roller.

In particular, the winding roller is the drive roller that drives the cross-wound bobbin by applying pressure to the thereto or the tube provided for the construction of a cross-wound bobbin. However, the rotation creates in particular air turbulence, and the winding roller itself can be a carrier and therefore a distributor of contaminants. In particular, the wound thread material slides past it and, as a result, abrasion is also transferred to the winding roller, as well as other loose particles to the winding roller. An at least partial housing thus serves, in particular, to impede a transfer of contaminants to the thread guide housing. This increases the time it takes for the contaminants to accumulate and become a problem, as described in detail, which would have to be solved by maintenance or repair. The downtimes are thus reduced, and the duration of the operation of the textile machine is increased. This saves resources.

The shielding of a winding roller can be provided as a measure together with the features described elsewhere. This further improves the protection against contaminants that the other features and devices described here provide. This can lead to mutually reinforcing effects, since the air turbulence is slowed down, as described above, wherein however the capacity of the other features and devices can also be correspondingly adjusted, since fewer contaminants can originate from the winding roller. However, the implementation of a winding roller shield (as a synonym for at least partial enclosure, also known as a spoiler) can also reduce the entry of contaminants into the thread guide housing and onto the thread guide.

Alternatively or additionally, a thread guide cover can be formed which is arranged relative to the thread guide in order to shield at least one axis starting from the cross-wound bobbin to the thread guide. The entry of previously described contaminants into the thread guide housing can thereby be reduced. Additionally or alternatively, however, a transfer of the contaminants described in detail above onto the thread guide can also be reduced. An entry of contaminants onto the thread guide housing or onto the thread guide is thereby slowed down; it therefore, in particular, takes longer until the contaminants are so great that it leads to a noticeable problem in the reproducibility of the cross-wound bobbin winding, as already described elsewhere.

According to a further aspect, the traversing device can have a pulling device, in particular an endless pulling device. This is in particular drivable in such a way as to perform a traversing movement (also referred to as a stroke movement). A sealing lip can be designed and arranged in such a way as to at least partially enclose the pulling device, in particular around the endless pulling device in a region, in such a way as to reduce interaction with an inner region and/or an outer region of the thread guide housing. A smaller amount of contaminants is thereby introduced into the thread guide housing by the pulling device, in particular the endless pulling device. The sealing lip can be designed and arranged in such a way as to comprise a lower edge of the pulling device, in particular the endless pulling device, in particular in the region of the movement clearance of the thread guide. This further seals the lower edge of the pulling device, in particular the endless pulling device, which in embodiments that, without such a sealing lip, can seal the thread guide housing inwards/outwards in the region of the movement clearance. In embodiments that, without such a sealing lip, can seal the thread guide housing inward/outward in the region of the movement clearance, it can be provided that the actual sealing can be exposed to partial fluctuations. This can be based on the fact that, for example, when the thread guide housing is operated in overpressure, without a previously described defined outlet, material and contaminants also emerge via any seals if the overpressure applied to the interior of the thread guide housing exceeds the contact pressure of the pulling device, in particular the endless pulling device in the region of the traversing movement. In some embodiments, the pulling means itself can be used as a sealing means, wherein however leakages can arise due to the movement. This would then again reduce the cleaning capacity, which is achieved by overpressure application, since the pulling device, in particular designed as an endless pulling device, can also introduce contaminants coming from the inside of the thread guide housing back into the inside of the thread guide housing, or cannot allow these contaminants to escape to the outside, and can thereby also cause a redistribution of contaminants in the thread guide housing. The sealing lip increases the seal of the thread guide housing toward the outside in the region of the movable parts of the traversing device. Additionally or alternatively, however, the capacity of the pulling device, in particular the endless pulling device, can also be reduced in order to receive and/or distribute contaminants from the interior of the thread guide housing. The same applies to the redistribution and reception of contaminants from the exterior space.

The endless pulling device can in particular be a belt, a V-belt or a toothed belt. In alternative embodiments, a pulling device in the form of a pull rod and/or a pull plate can be provided. The pull rod can also be designed as a toothed rack or the pull plate as a toothed plate. Wedges can also be provided instead of teeth.

The region of the traversing movement, also called the traversing movement region, can therefore denote the region of the traversing device that represents the region in which the thread guide moves, i.e., has a movement clearance. This movement clearance is not to be equated with a movement clearance in the sense of an imprecise positioning around zero, for example the reproducibility of reaching the zero position.

The object is achieved by an independent aspect by a thread guide housing for a thread traversing device, as described in detail. This can improve the quality of cross-wound coil production, improve the reproducibility of their production and increase the reproducibility of the resulting cross-wound bobbins, and downtimes can be minimized and thereby resources conserved. The thread guide housing can be described by the previously described features, advantages, and properties of the thread traversing device.

The object is achieved by an independent aspect, in particular by a textile machine. In particular, the textile machine has a thread traversing device as described in detail elsewhere. Alternatively or additionally, the textile machine has a thread guide housing, as described in detail. This can improve the quality of cross-wound coil production, improve the reproducibility of their production and increase the reproducibility of the resulting cross-wound bobbins. Furthermore, downtimes can be minimized and resources thereby protected. The textile machine can be described by the previously described features, advantages, and properties of the thread traversing device.

The object is achieved according to an independent aspect, in particular by a method for cleaning a thread guide housing, in particular a thread guide housing as described above. In this case, the method in particular has at least one of the following steps: establishing fluidic communication between at least one overpressure system and the thread guide housing; alternatively or additionally, applying overpressure to the thread guide housing; further alternatively or additionally, discharging the overpressure through a defined exit point. This can improve the quality of cross-wound bobbin production. Furthermore, the reproducibility of their production can be improved, and the reproducibility of the resulting cross-wound bobbins can be increased. Downtimes can also be minimized and resources thereby protected. The method can be described by the previously described features, advantages, and properties of the thread traversing device and those of the textile machine.

According to one embodiment of a method, cleaning cycles can be predefined. This can take place relative to a pending thread connection after an event, in particular after an intervention. The intervention can be selected from a cleaning intervention, a thread breakage, and/or a bobbin change. In particular, it can thereby be cleaned cyclically without having to rely on downtimes of the textile machine. Instead, cleaning can be carried out flexibly and as required.

According to one embodiment, the intensity and/or the duration of the cleaning cycle can be variable. This allows the cleaning to be adapted to the actually occurring requirements in order to carry out cleaning as efficiently as possible.

The method can have cleaning, in particular at least part of the cleaning cycle, which is carried out while the thread is running, in particular simultaneously with the production of a cross-wound bobbin. The method is thus in particular no longer dependent on downtimes.

According to an independent aspect, a control device can be provided which is designed and configured to carry out one of the methods described above. As a result, the effects presented above and correspondingly described in detail and the associated advantages are realized. The control device can be arranged at the work station or at a central location of the textile machine. In any case, the control device for carrying out the method is assigned to the thread traversing device and is operatively connected thereto.

In summary and in other words, a number of implementations can keep down a level of contamination in a thread guide housing, as well as a thread guide, for an extended period of time. It is thereby possible that cleaning can also take place independently of an interruption of the production of the cross-wound bobbin. Any approaches can be applied individually, i.e., separately, or together they can also create synergies by jointly leading to a further reduction in the contamination load.

In this case, a first described aspect relates in particular to applying compressed air to the thread guide housing, wherein the compressed air can be supplied to the thread traversing device via a defined outlet. In this case, either the thread guide housing is subjected to overpressure from the inside, wherein a defined outlet allows an outflow in a defined manner to thereby establish a fluid flow in the interior of the thread guide housing. As a result, contaminants can be carried out of the thread guide housing, in particular its interior. Alternatively or additionally, however, a defined outlet can also be arranged in such a way that the thread guide is blown directly. In this case, one can speak of external overpressure application since a fluid flow external to the thread guide housing can thereby be formed, which makes it possible for contaminants to be carried away from the thread guide, in particular in a laminar fluid flow. The application of overpressure to the thread guide housing allows in this case easy installation and gets by in particular without software changes to the control electronics, but can also be integrated into blowing sensors. Compressed air connections can already be present at the work station and can be used, for example for rotor or sensor cleaning, which can be carried out during thread connection. The compressed air can be applied to the thread guide housing simultaneously with thread connection, or independently through an independent valve. External and internal blowing are controlled in particular in a staggered manner, in particular by a correspondingly described control device. In addition, the aspect of the overpressure application can be combined with the other described approaches and aspects, such as the design of thread guide carriages, the covers of the winding roller (the covers can also be referred to as spoilers) and the protective plate for the thread guide, as described in detail. Even if described in a corresponding combination with the overpressure application, each individual aspect, as described here and elsewhere, can also result in the degree of cleanliness of the thread guide housing and thread guide being improved over a longer time than if these respective aspects with the described features are not implemented. Therefore, it can also be advantageous to select only individual aspects, or else to implement individual combinations of aspects. This can have the advantage that the costs for implementation and possibly for retrofitting textile machines can be reduced, since all measures do not necessarily have to be taken, but rather can be used according to requirements.

A further described aspect relates in particular to the design of the thread guide carriage or, in addition or alternatively thereto, the design of the anchoring and/or mounting of the guide rods. The thread guide carriages can have guides that terminate with an outer edge or guides that are routed inwards. The guides are in particular movably mounted on the guide rods in order to enable a stroke movement for a traversing of the thread guide. In this way, more space can be created in a zero position for dirt (contaminants in particular from short fiber material) in order to thereby prevent or limit migration or meandering of a zero position. Alternatively or additionally, the occurrence of migration or meandering of the zero can thereby be postponed in time (as much as possible). The press seats can also be correspondingly designed to create a receptacle for contaminants in the region of the stop positions of the thread guide carriages in order to be able to thereby maintain a stable zero position for as long as possible.

Another described aspect relates to the implementation of so-called spoilers which function as an enclosure and/or shielding of the winding drum. These are in particular designed open toward the pulling device, for example the belt, which means that the fibers falling from above can only be partially entrained by the air turbulence since the spoilers are able to locally restrict the air turbulence, while a part of the fibers can simply fall through freely, i.e., are not introduced into the thread guide housing by the turbulence.

In order to also be able to better protect the thread guide from contaminants, in a further aspect, a thread guide cover can be designed which prevents short fibers from simply falling through between the thread guide and the winding drum, as described above. Instead, the thread guide cover is designed and arranged in such a way that the fibers, which otherwise fall between the thread guide and winding drum, are entrained upwards by the winding drum and thereby are carried away from the thread guide, as well as the thread guide housing.

In the following, exemplary embodiments of the invention are described in more detail with reference to figures, showing schematically and by way of example:

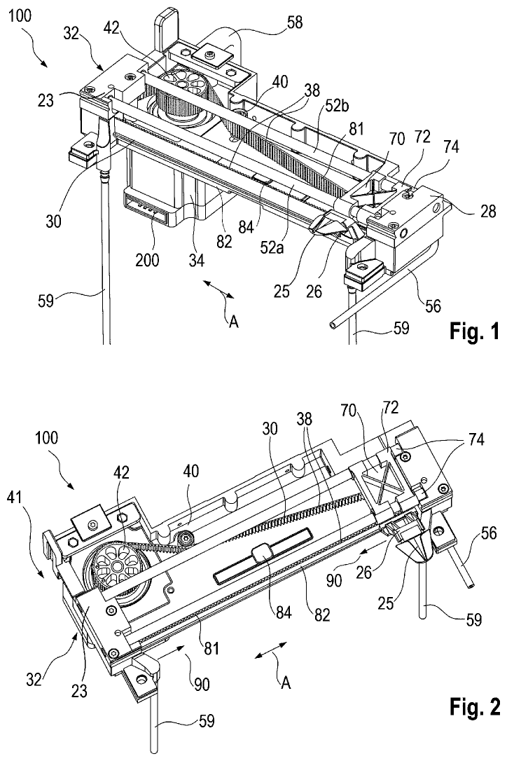

FIG. 1 shows an oblique view of a thread traversing device (obliquely at the front);

FIG. 2 shows a plan view of a thread traversing device;

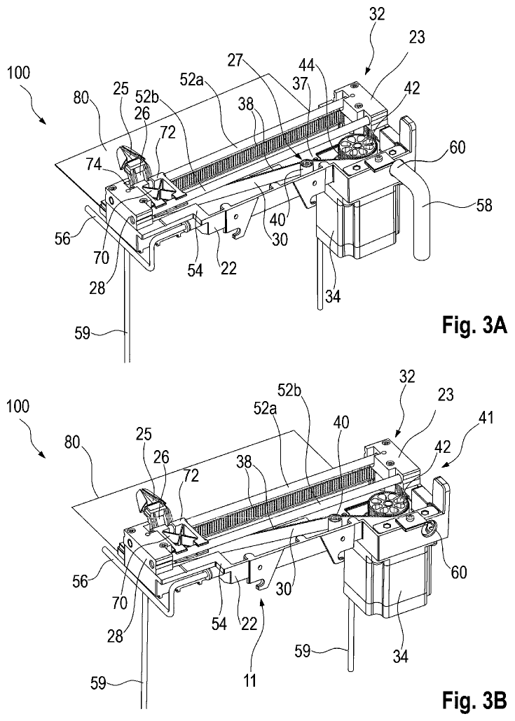

FIG. 3A shows a rear view of a thread traversing device (obliquely from the rear) with a suction device;

FIG. 3B shows a rear view of a thread traversing device (obliquely to the rear) with a defined outlet;

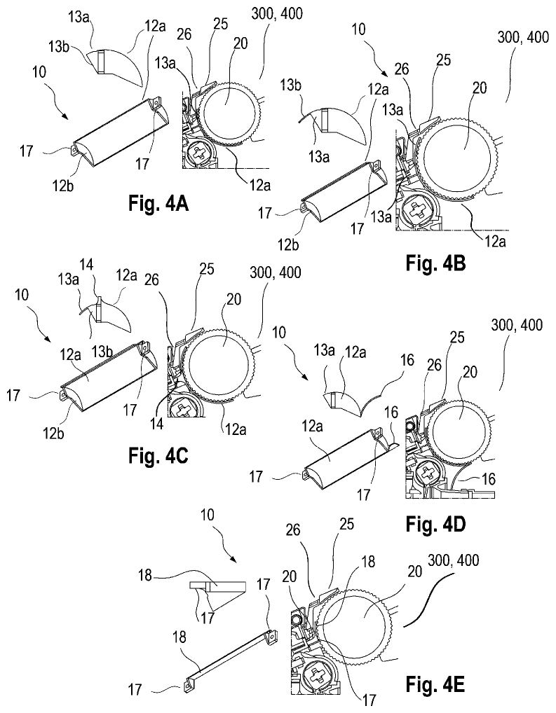

FIG. 4A shows a first embodiment of an enclosure;

FIG. 4B shows a second embodiment of an enclosure;

FIG. 4C shows a third embodiment of an enclosure;

FIG. 4D shows a fourth embodiment of an enclosure;

FIG. 4E shows a fifth embodiment of an enclosure; and

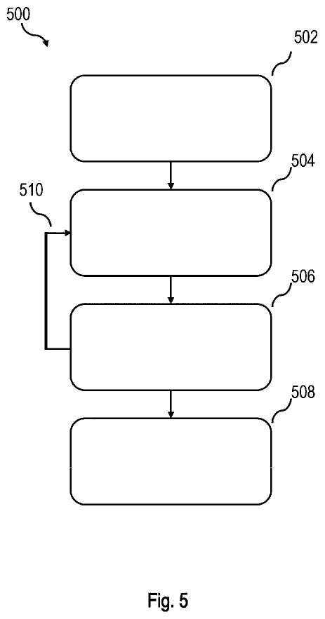

FIG. 5 shows a schematic representation of a method.

The same reference signs are used for elements and structures having the same effect and/or of the same type.

In textile machines 400 for the production of cross-wound bobbins, as described at the outset, a regenerated or a coarse thread with a high proportion of short fibers of approx. 1 mm in length can lead to contaminants, in particular in a thread guide housing 32 or on the thread guide 25. This can lead to offsets on the cross-wound bobbins, which can impair the quality of these cross-wound bobbins. The contaminants accumulate at different points of the thread guide or in the thread guide housing of a thread traversing device 100. This can make time-consuming and therefore resource-intensive cleaning necessary to restore the initial quality of the cross-wound bobbins.

FIG. 1 shows by way of example a thread traversing device 100 for a winding device of a textile machine 400 producing cross-wound bobbins. The thread traversing device 100 is also assigned a control device 200, from which only the connection to the drive of the thread traversing device 100 is shown in FIG. 1. Furthermore, the thread traversing device 100 has in particular a thread guide housing 32 and a thread guide 25. The thread guide housing 32 has a wall 22 which forms the thread guide housing 32. The thread guide housing is thereby delimited by two press seats 23, 28 on the end faces. In particular, a motor-side press seat 23 and a further press seat 28 are provided. The thread guide housing 32 is largely closed, wherein the thread guide housing 32 is only shown open at the top in the figures to better illustrate the structure. A traversing device 38 can also be designed and arranged to reversibly traverse along a direction A of the axis of the cross-wound bobbin to be produced. The traversing device 38 is designed here as an endless pulling device, in the form of a toothed belt 30 with teeth. This toothed belt 30 is in particular drivably held by a drive pinion 42 and is held in tension by a tension roller 40. The drive is thereby provided by a motor which can be arranged in a motor base 34, wherein the motor drives the drive pinion 42. The tension roller 40 is a purely passively entrained roller. As can be seen in FIG. 3B, the thread guide housing 32 has an anchoring device 11.

The thread guide housing 32 is in particular designed, and the traversing device 38 is in particular associated with the thread guide housing 32, in such a way that the thread guide 25 can reversibly traverse in a work station 300 of the textile machine 400 along a direction of the axis of rotation A of the cross-wound bobbin to be produced. In this case, the toothed belt 30, which is in engagement with the drive pinion 42 via teeth 81, can be moved alternately rotating forwards and backwards in rapid succession. In particular, the thread guide is connected to the toothed belt 30 via a thread guide shoe 26, which is why a stroke movement to the left or right is caused. On one side that faces the winding drum (not shown) and the cross-wound bobbin (not shown), the toothed belt 30 can be arranged in a sealing lip 82. This closes off the transition from an interior of the thread guide housing 32 to an outer space in such a way as to reduce, in particular, the transfer of fluid and/or of contaminants entrained in this fluid. The sealing lip 82 can be designed to withstand an applicable maximum pressure, in particular without fluid leakage across the toothed belt 30 and the sealing lip 82. Furthermore, the sealing lip 82 can be designed to guide the toothed belt 30. However, the sealing lip 82 can also be arranged and designed in such a way as to guide the regions of the teeth 81 of the toothed belt 30 that face the bottom side of the thread guide housing 32. As a result, it can be difficult for contaminants which can collect on the bottom to be entrained by the teeth 81 and distributed, in particular swirled, in the thread guide housing 32.

The thread guide 25 can be movably mounted via a thread guide carriage 70 on guide rods 52a, 52b via guides 72 on the thread guide carriage 70. The thread guide rods 52a, 52b can be pressed into a press seat 23, 28. A gap 74 is thereby formed in particular between the press seat 23, 28 and the guides 72. This is provided in particular in the region of the zeroing of the thread guide carriage 70 in order to receive fiber contaminants. In particular, the zeroing defines the starting point of the thread guide carriage movement in the direction of the axis A described in detail. In the event of A deviation (migration or meandering, as described elsewhere), from zero can lead to offsets on the bobbins, which can constitute a drastic reduction in quality. This can take place, for example, by an enrichment of contaminants between a motor-side press seat 23 and a corresponding stop position of the thread guide carriage 70, wherein the contaminants are pressed against the press seat 23, which can prevent a return to the original zero. The zero thus begins to migrate.

The guides 72 of the thread guide carriage 70 can be designed to maintain the gap to the press seat 23, 28 in the region of the pressing of the guide rods 52a, 52b in at least one of the stop positions of the thread guide carriage 70 on one of the press seats, in particular on the press seat 23 arranged on the motor side which defines the zero, but also on the press seat 28 arranged remote from the motor. In other words, space can be created to receive the contaminants. In particular, it is provided that the guides 72 do not protrude beyond the side line of the thread guide carriage 70, which bridges the gap of the two guide rods 52a, 52b, while in particular the regions of the pressing of the guide rods 52a, 52b are offset outwardly toward the end faces. Alternatively or additionally, the press seat 23, 28 in the region of the pressing of the guide rods 52a, 52b can be offset relative to a stop region for the stopping of the thread guide carriage 70 so as to maintain a gap 74 from the guides 72 in a stop position of the thread guide carriage 70. This means that a thread guide carriage 70 can also be used which has projecting guides 72.

Alternatively or additionally, at least a part of the guide rods 52a, 52b can be ⅞ free. Further alternatively, at least a part of the guide rods 52a, 52b can be completely free. This freedom relates, in particular, to the fact that there can be embodiments (not shown) which hold the guide rods 52a, 52b offset inwards, without pressing. As a result, it may be possible that when the thread guide carriage 70 assumes an end position, there is no stop at a press seat 23, 28, as a result of which no compression of the contaminants can occur at such a press seat. Furthermore, contaminants can be pushed directly by the guide rods 52a, 52b, which is why a return to zero is reversibly possible.

The thread guide housing 32 can be brought into fluidic communication with the fluid guide in order to apply overpressure to the thread guide housing 32. At least one overpressure system (not shown) can be designed which has at least one fluid guide. In this case, a first fluid guide can direct a compressed air supply 56 to the interior of the thread guide housing 32 to apply overpressure to the interior of the thread guide housing 32. The compressed air can therefore be applied to the thread guide housing 32 via at least one pressurized fluid connection 54 in order to apply compressed air to the interior of the thread guide housing 32. In particular, this can be a compressed air connection 54. The pressurized fluid supply 56 is connected to the pressurized fluid connection 54.

At least one defined outlet point 60 (see FIG. 3B) can be designed and arranged so as to divert fluid through the defined outlet point 60. Additionally or alternatively, the defined exit point 60 can be designed to allow the pressurized fluid introduced into the interior of the thread guide housing 32 to escape in a defined manner in order to form a defined pressurized fluid flow in the interior of the thread guide housing 32. In one embodiment, the outlet point 60 can be designed as an opening which can optionally also be provided with a valve. This enables simple implementation. In another embodiment, it can be a pressurized fluid discharge 58 for discharging a fluid applied under overpressure from the thread guide housing 32. Embodiments can also be provided in which multiple exit points 60 are provided, of which some are designed as pure openings, wherein others are designed as a pressurized fluid discharge 58. In particular, however, the pressurized fluid discharge 58 is also connected to a suction system (not shown). In this way, an equilibrium with the applied overpressure can be set in a controlled manner, in particular in order to be able to form a laminar fluid flow in the thread guide housing 32. In other words and in summary, the exit point 60 can be designed as a suction point 58 so as to be connected to a suction system in order to extract the pressurized fluid from the interior of the thread guide housing 32 in a defined manner via the suction point 58 in order to form a defined fluid flow in the interior of the thread guide housing 32.

In this case, the two embodiments in which an outlet point 60 can be designed as a pure opening and in which an outlet point 60, which can be designed as a suction point 58, are opposite one another in FIGS. 3A and 3B. The outlet point 60, designed purely as an opening, defines in particular a defined outlet of pressurized fluid, which can, however, be purely passive (see FIG. 3A). In contrast, the exit point 60, which can be designed in particular as a suction point 58, defines an active control of the removal of pressurized fluid. As a result, the overpressure level can be set by two independent degrees of freedom, the supply of pressurized fluid by the pressurized fluid supply 56, as well as by the discharge of pressurized fluid via the suction point 58 (see FIG. 3B).

FIG. 2 shows a plan view of a thread traversing device 100. For a description of the details, refer to the description with reference to FIG. 1. FIG. 2 differs in particular from the embodiment of FIG. 1 in that a suction point 58 is not provided, but only an exit point 60 which is designed as an opening. A corresponding detailed rear view is shown in FIG. 3B and also described in detail in this regard. Furthermore, the embodiment of the thread traversing device 100 has in particular an external overpressure application. In this case, as shown here, two outlet points 90 can be arranged and designed so as to form a defined pressurized fluid flow which blows the thread guide 25. This takes place in particular during a traversing process. The outlet points 90 are supplied with negative pressure by means of the compressed air supply 59. In so doing, a pressurized fluid flow is triggered which blows in the direction of the arrows symbolizing the outlet points 90 and which blows along the thread guide 25, but in particular also on the thread guide shoe 26. This can make an accumulation of fibers on the thread guide 25 or the thread guide shoe 26 more difficult. This can prevent an accumulation of fibers. Maintenance is thereby greatly reduced. FIG. 2 also shows by way of example that any holes can be closed by seals 84 in order to further impede penetration of contaminants.

FIGS. 3A and 3B show rear representations of two embodiments. FIG. 3A shows the first embodiment, wherein a suction point 58 is provided as an exit point 60. FIG. 3B shows a second embodiment, wherein a defined exit point 60 is provided in the form of an opening. The opening is in particular arranged on a side facing away from a work station. By positioning in connection with the application of overpressure, penetration of contaminants through this opening can be made more difficult or completely prevented.

A thread guide cover 80 can be formed and arranged relative to the thread guide 25 in such a way as to shield at least one axis starting from the cross-wound bobbin to the thread guide 25. This at least one axis can in particular be the direction of falling, i.e., the direction of gravity from the cross-wound bobbin. This can prevent falling yarn residues from settling on the thread guide 25 and/or on the thread guide shoe 26. The thread guide shoe 26 and the thread guide 25 can thereby be kept clean, in particular over a longer time. For further details on the two embodiments, reference is made to the statements made above regarding FIGS. 1 and 2.

FIG. 4A to 4E show different exemplary embodiments of an at least partial housing 10 of a winding roller 20 arranged and designed in such a way as to brake or block a fluid flow between the winding roller 20 and at least one element selected from the thread guide 25 or the thread guide housing 32. In this case, FIG. 4A to 4E are designed to be able to determine angular relationships and dimensions relative to each other.

FIG. 4A depicts a housing, a so-called spoiler 10, which can be associated with a winding roller 20 by means of an anchor 17 in such a way that the winding roller 20 can be at least partially encapsulated. The anchor 17 divides the spoiler 10 in particular into two regions: a region which extends along the winding roller extension and which, in an installed final state between the anchor 17 and the thread guide, shields the winding roller 20 in its longitudinal extension. In particular, a lateral thread guide guard 13b is also provided, as well as a lateral roller shield 12b. In the first embodiment, the lateral thread guide guard 13b is formed in a form-fit with the thread guide guard 13a along the longitudinal axis. The angular rotation from the anchoring 17, measured to the end of the lateral roller shield 12b, which in particular is also form-fit with the roller shield 12a along the roller axis, is between 90° and 120°, further in particular between 100° and 110°. Starting from the anchoring 17, the thread guide guard 13 is in particular between 0° and 30°, further in particular between 10° and 20°. The other regions of the spoiler 10 can be combined with the embodiments shown elsewhere.

FIG. 4B shows a second embodiment of a spoiler 10, wherein the thread guide guard 13a projects beyond the lateral thread guide guard 13b along the longitudinal axis. In particular, there is therefore no longer a form fit. Furthermore, the lateral thread guide guard 13b can still fulfill the previously stated angle specifications, wherein the thread guide guard 13a can protrude along the longitudinal axis in particular between 10° and 45°, more particularly between 15° and 25°, over the lateral thread guide guard 13b. This further improves a deflection of the air flow during a rotation of the winding reel because the spoiler projects closer to the thread guide and can omit the thread guide shoe 26, which is particularly affected by contaminants. The other regions of the spoiler can be combined with the embodiments presented elsewhere.

FIG. 4C shows a third exemplary embodiment of a spoiler 10 in which the anchoring protrudes outwards, i.e., from the axis of rotation A of the winding reel 20 in an assembled state of winding reel 20 and spoiler 10. This projection can also be referred to as a standing collar 14. This improves assembly and stabilizes the installation position. The other regions of the spoiler can be combined with the embodiments presented elsewhere.

FIG. 4D shows a fourth exemplary embodiment of a spoiler 10 in which an inverse shield 16 is formed toward the work station, which is connected to the form-fitting roller shield 12a along the roller axis. Inverted in this case refers in particular to the fact that the curvature and orientation of the roller shield 12a is inverted (for example, upward facing contour where the contour faces downwards). However, the inverse shielding 16 in particular has the same curvature as the roller shield 12a along the roller axis. The other regions of the spoiler can be combined with the embodiments presented elsewhere.

FIG. 4E shows a fifth exemplary embodiment of a spoiler 10. In this case, the roller shields are omitted, and only a form-fitting thread guide guard shortened to 5° to 10° is provided, which is designed as a flat shield 18. Material can thereby be saved.

FIG. 5 schematically shows a method 500 for cleaning a thread guide housing 32, in particular a thread guide housing as described elsewhere. In this case, the method 500 has, in particular, the step of stopping 502 a textile machine 400 in order to be able to carry out a cleaning step. Stopping 502 is not absolutely necessary if the cleaning step is in particular a cyclic blowing out of the above described embodiments. However, a stop 502 can be necessary for acyclic cleaning, for example in the event of a thread breakage or if a new piecing process is to be carried out.

A further step can in particular be production 504 of fluidic communication between at least one overpressure system and the thread guide housing 32. This can be done automatically by a control device 200, for example by the corresponding valves being opened. Alternatively, a connection can also be made manually. A further step can be an application 506 of overpressure to the thread guide housing 32. This allows the effects described above and the associated advantages to be implemented. A further step can be a discharge 508 of the overpressure through a defined exit point 60. In this case, suction can also be provided by a suction device in order to form a corresponding, in particular laminar fluid flow, with a fixedly defined overpressure level.

The method can have predefined cleaning cycles 510, wherein the cleaning cycles 510 can take place relative to an event such as a pending thread connection, or in particular relative to an intervention. An intervention can in particular be selected from a cleaning intervention, a thread breakage, and/or a bobbin change. The intensity and/or the duration of the cleaning cycle 510 can be variable. This makes it possible to adapt the cleaning cycle 510 in accordance with requirements. A cleaning, in particular at least part of the cleaning cycle 510, can take place when the thread is running, in particular simultaneously to the production of a cross-wound bobbin.

“Can” in particular refers to optional features of the invention. Accordingly, there are also developments and/or exemplary embodiments of the invention which additionally or alternatively have the respective feature or the respective features.

From the combinations of features disclosed in the present case, isolated features can also be taken as needed and used by resolving a structural and/or functional relationship possibly existing between the features in combination with other features for delimiting the subject matter of the claim.

### LIST OF REFERENCE SIGNS

10 Spoiler/shielding/partial housing
11 Anchoring device
12a Roller shield along the roller extension
12b Lateral roller shield
13a Thread guide guard along the roller extension
13b Lateral thread guide guard
14 Standing collar
16 Inverse shield, work station
17 Anchoring
18 Flat shield
20 Winding drum/winding roller
22 Wall
23 Press seat
25 Thread guide
26 Thread guide shoe
28 Press seat
30 Toothed belt
32 Thread guide housing
34 Motor base
38 Traversing device
40 Clamping roller
41 Drive device
42 Drive pinion
52a, 52b Guide rods
54 Pressurized fluid connection or compressed air connection
56 Pressurized fluid supply or compressed air supply, thread guide housing
58 Pressurized fluid guide or compressed air discharge, thread guide housing/suction point
59 Pressurized fluid supply or compressed air supply for external blowing
60 Defined exit point
70 Thread guide carriage
72 Guides
74 Gap
80 Cover
81 Teeth
82 Sealing lip
84 Hole closure
90 Compressed air application, outside/exit point
100 Thread traversing device
200 Control device connection/control device
300 Work station
400 Textile machine
500 Method for cleaning a thread guide housing
502 Stopping a textile machine
504 Establishing fluidic communication between at least one overpressure system and the thread guide housing
506 Applying overpressure to the thread guide housing
508 Discharging the overpressure through a defined exit point
510 Cleaning cycle

1. A thread traversing device for a winding device of a textile machine producing a cross-wound bobbin, the thread traversing device comprising:
a thread guide housing having a thread guide; a traversing device designed and arranged to reversibly traverse along a direction of an axis of the cross-wound bobbin to be produced; and
at least one overpressure system having at least one fluid guide;
wherein the thread guide housing is designed, and wherein the traversing device is associated with the thread guide housing, in such a way that the thread guide reversibly traverses in a work station of the textile machine along a direction of an axis of rotation of the cross-wound bobbin to be produced;
wherein the thread guide housing can be brought into fluidic communication with the at least one fluid guide in order to apply overpressure to the thread guide housing; and
wherein at least one defined exit point is designed and arranged in such a way that fluid can be diverted through the at least one defined exit point.

2. The thread traversing device according to claim 1, wherein pressurized fluid is applied to the thread guide housing via at least one pressurized fluid connection in such a way that the pressurized fluid is applied to an interior of the thread guide housing.

3. The thread traversing device according to claim 1, wherein the at least one defined exit point is designed to allow pressurized fluid introduced into an interior of the thread guide housing to escape in a defined manner in order to form a defined pressurized fluid flow in the interior of the thread guide housing.

4. The thread traversing device according to claim 1, wherein the at least one defined exit point is a suction point designed to be connected to a suction system in order to extract pressurized fluid from an interior of the thread guide housing in a defined manner via the suction point in order to form a defined fluid flow in the interior of the thread guide housing.

5. The thread traversing device according to claim 1, wherein the at least one defined exit point is arranged and designed in such a way as to form a defined pressurized fluid flow which blows the thread guide.

6. The thread traversing device according to claim 1, wherein the thread guide is mounted via a thread guide carriage on guide rods via guides, and wherein the guide rods are pressed into a press seat, wherein a gap is formed between the press seat and the guides in order to receive fiber contaminants.

7. The thread traversing device according to claim 6, wherein:
the guides of the thread guide carriage are designed such that, in a stop position of the thread guide carriage at the press seat, the gap to the press seat is maintained in a region where the guide rods are pressed in; and/or
the press seat in a region of a pressing of the guide rods is offset relative to a stop region for stopping of the thread guide carriage so as to maintain a gap from the guides in a stop position of the thread guide carriage; and/or
at least a portion of the guide rods is ⅞ free or is completely free.

8. The thread traversing device according to claim 1, wherein:
an at least partial housing of a winding roller is arranged and designed in such a way as to brake or block a fluid flow between the winding roller and at least one element selected from the thread guide and the thread guide housing; and/or
a thread guide cover is formed and arranged relative to the thread guide in such a way as to shield at least one axis starting from the cross-wound bobbin to the thread guide.

9. The thread traversing device according to claim 1, wherein:
the traversing device comprises a pulling device which can be driven so as to carry out a traversing movement; and
a sealing lip is designed and arranged so to at least partially grip the pulling device in a region in order to reduce interaction with an outer region of the thread guide housing.

10. The thread guide housing for the thread traversing device according to claim 1.

11. A textile machine having the thread traversing device according to claim 1 and/or having a thread guide housing for the thread traversing device.

12. A method for cleaning the thread guide housing according to claim 10, the method comprising:
establishing fluidic communication between at least one overpressure system and the thread guide housing;
applying overpressure to the thread guide housing; and
discharging the overpressure through the at least one defined exit point.

13. The method for cleaning the thread guide according to claim 12, wherein cleaning cycles are predefined relative to a pending thread connection after an intervention, wherein the intervention is selected from a cleaning intervention, a thread breakage, and/or a bobbin change.

14. The method according to claim 12, wherein an intensity and/or a duration of a cleaning cycle is/are variable.

15. The method according to claim 11, wherein cleaning takes place when the thread is running.

16. A control device designed and configured to carry out the method according to claim 12.
